(19) United States
(12) Patent Application Publication
(10) Pub. No.: US 2025/0026894 A1
(43) Pub. Date: Jan. 23, 2025

(54) METHOD FOR MANUFACTURE OF A POLYMER COMPOSITION

(71) Applicant: SABIC GLOBAL TECHNOLOGIES B.V., Bergen op Zoom (NL)

(72) Inventors: Joshua Arie Van Den Bogerd, Tholen (NL); Rob Boonman, Oosterhout (NL); Erik Hermans, Kapellen (BE)

(21) Appl. No.: 18/713,806

(22) PCT Filed: Nov. 28, 2022
(86) PCT No.: PCT/EP2022/083490

§ 371 Date: May 28, 2024

(30) Foreign Application Priority Data
Dec. 3, 2021 (EP) 21212179.2

(51) Int. Cl. C08J 3/20; B29C 48/285; B29K 69/00; B29K 105/16; B29K 507/04; C08K 3/04

(52) U.S. Cl. CPC C08J 3/20; C08K 3/04; B29C 48/297; B29K 2069/00; B29K 2105/16; B29K 2507/04; C08J 2369/00

(57) ABSTRACT

The present invention relates to a method for the manufacture of a polymer composition comprising polymer and carbonaceous filler comprising the steps of: a. introducing a first portion of polymer and a first portion of carbonaceous filler into a first feed section of an extruder, b. introducing a second portion of polymer and optionally a second portion of carbonaceous filler into a second feed section located downstream of the first feed section of the extruder, and c. extruding the resulting polymer composition; wherein the polymer composition comprises 0.01 to 3 wt. % of the carbonaceous filler relative to the total weight of the polymer composition.

### CROSS REFERENCE TO RELATED APPLICATIONS

This application is a National Stage application of PCT/EP2022/083490, filed Nov. 28, 2022, which claims the benefit of European Application No. 21212179.2, filed Dec. 3, 2021, both of which are incorporated by reference in their entirety herein.

### BACKGROUND

The present invention relates to a method for the manufacture of a polymer composition comprising a polymer and a carbonaceous filler and a polymer composition obtainable by the said method. The present invention further relates to a molded article made by the said method or the polymer composition obtained thereof.

Many applications, such as for example pipe or fuel tanks require the use of carbonaceous fillers, typically carbon black that is used to color the resin. Carbon black is generally available as a black powder or in pelletized form and can be difficult to use as fillers for sheets and films applications requiring surface smoothness due to the presence of aggregates of carbon black. Accordingly, it is important that the carbon black is sufficiently dispersed in the polymer matrix.

This problem has been addressed in JPS5458747A wherein a thermoplastic resin is dissolved in a solvent, a carbon black suspension in water is mixed with the same and then the water and solvent are separated to produce a composition in which the carbon black is efficiently dispersed in the resin.

US2005027059A1 discloses a method for minimizing nanofiller agglomeration within a polymeric material, which includes the step of introducing the nanofiller at predetermined parameters into the downstream of the area of the extruder wherein the polymeric material had been substantially melted and mixed.

JPH09272742A discloses a process by which a conductive resin composition containing carbon black and having good surface smoothness and stable conductivity is produced through continuous kneading/extrusion of the resin together with the carbon black in the upstream region of the barrel in a kneading extruder to produce a master batch, subsequently introducing the remainder of the resin in the downstream region of the barrel, and kneading the resultant mixture to dilute the master batch.

EP1923419 discloses a method for producing a conductive masterbatch comprising a polyamide resin and a carbonaceous filler, characterized by comprising a first step of melt-kneading a first polyamide and the carbonaceous filler to form a melt-kneaded product and a second step of melt-kneading the melt-kneaded product and a second polyamide, in this order.

U.S. Pat. No. 9,056,957 discloses a masterbatch comprising pigment and demolding agent. The demolding agent is selected from the group comprising low molecular weight polyolefin oils, low molecular weight polyolefin waxes, montan waxes and aliphatic or aromatic carboxylic acid esters of fatty acids and/or fatty alcohols, wherein the pigment content of the masterbatch is from 3 to 70 wt. %, based on the total weight of the masterbatch. The masterbatch is suitable for preparation of a polymer composition having improved pigment dispersion.

### SUMMARY

During processing of polymer composition with carbonaceous fillers, it has been found that agglomeration of the carbonaceous fillers may occur. This agglomeration of the fillers may affect the final properties of the polymer composition through inhomogeneous dispersion. Such agglomerates, when large enough and present at the surface may create defects that result in poor surface aesthetics. A typical defect occurring in a carbon black containing polymer compositions is known as a ‘pit’. These pits are small surface valleys, which cause visual disturbance.

It is an object of the present invention to provide a method for the manufacture of a polymer composition comprising a polymer and a carbonaceous filler wherein the dispersion of the carbonaceous filler is improved.

It is another object of the invention to provide for a method for the manufacture of a polymer composition comprising a polymer and a carbonaceous filler wherein surface defects due to the carbonaceous filler agglomerates in a molded part is reduced to a minimum.

### BRIEF DESCRIPTION OF THE DRAWINGS

FIG. 1 schematically shows a schematic representation of the extruder and some of the method steps according to embodiments.

### DETAILED DESCRIPTION

The present inventors found that the dispersion of the carbonaceous filler could be improved and accordingly the formation of surface defects due to agglomerates to be reduced, by feeding a first portion of polymer together with the carbonaceous filler at a first feed section of an extruder and a second portion of the polymer at a section downstream of the first feed section in the extruder. Without willing to be bound to it, the present inventors believe that the addition of an amount of polymer downstream in the extruder results in an increase in viscosity, which in turn leads to an increased shear that prevents agglomeration and supports the breaking up of carbonaceous filler agglomerates.

The present inventors have found a method for the manufacture of a polymer composition comprising a polymer and a carbonaceous filler wherein a portion of the polymer is added into a second feed section located downstream of a first feed section of the extruder, rather than all the polymer being fed through the first feed section of the extruder.

Accordingly, the present invention relates to a method for the manufacture of a polymer composition comprising polymer and carbonaceous filler comprising the steps of;
a. introducing a first portion of polymer and a first portion of carbonaceous filler into a first feed section of an extruder,
b. introducing a second portion of polymer and optionally a second portion of carbonaceous filler into a second feed section located downstream of the first feed section of the extruder, and
c. extruding the resulting polymer composition;
wherein the polymer composition comprises 0.01 to 3 wt. % of the carbonaceous filler relative to the total weight of the polymer composition.

By application of the invention, the foregoing objects are met, at least in part.

The invention will now be described in more detail.

### Polymer

While the present invention in its broadest sense is not limited with respect to the polymer in the polymer composition it is preferred that the polymer is selected from the group consisting of polycarbonate, polyester, polypropylene, polyethylene, polyamide, polyetherimide, styrene polymers, styrene copolymers and mixtures of two or more of the foregoing polymers.

Preferably, the polymer composition comprises or consists of polycarbonate. Thus, the polymer composition preferably comprises at least 50 wt. %, preferably at least 60 or 75 wt. %, more preferably at least 95 or 99 wt. % of polycarbonate based on the amount of polymer in the polymer composition. In that respect the polycarbonate may be a single polycarbonate of a mixture of at least two different polycarbonates. Polycarbonates may differ in molecular weight, their method of manufacture, or their comonomer content in case of a polycarbonate copolymer. Polycarbonates manufactured with the so-called melt process (“melt polycarbonate”) and the so-called interfacial process (“interfacial polycarbonate”) are regarded as different polycarbonates because they chemically differ in terms of number of terminal hydroxy groups and an amount of induced branching, often referred to as Fries branching units.

In accordance with the present invention, it is possible to use a mixture of two or more polycarbonates, which mutually differ in molecular weight and/or melt flow ratio. The present invention can also be extended to a polymer composition comprising polycarbonate and at least one further polymer component. The further polymer component may be one or more of acrylonitrile/butadiene/styrene copolymer (ABS), methyl methacrylate/butadiene/styrene copolymer (MBS), styrene/butadiene/styrene copolymer (SBS), styrene/acrylonitrile copolymer (SAN), acrylonitrile/styrene/acrylonitrile copolymer (ASA), polybutylene terephthalate (PBT), polyethylene terephthalate (PET), unsaturated polyester (UPES), polyamide (PA), thermoplastic urethane (TPU), polystyrene (PS), high impact polystyrene (HIPS), polyvinyl chloride (PVC).

In the context of the present invention, it may be preferred that the amount of the polymer is relatively high so that it is preferred that the amount of the polymer in the composition is at least 90 wt. %, more preferably at least 95 wt. % or even at least 99 wt. % based on the weight of the molding composition. For the purpose of the invention, the polymer is introduced in the extruder in particulate form, preferably in the form of a powder or pellet in at least one of the feed section, preferably in both the feed sections. The cross-section of the polymer pellet perpendicular to the longitudinal direction may have a circular shape or an elliptical shape. Further, the pellet may have a cylindrical shape, an elliptic cylindrical shape, or a spherical shape, and in particular, it is preferred that it has a cylindrical shape or an elliptic cylindrical shape.

### Carbonaceous Filler

The carbonaceous filler in the present invention is selected from the group consisting of graphite, expanded graphite, graphene, carbon fiber, carbon nanotubes, carbon black, or a combination of at least two of the foregoing carbonaceous fillers. For the purpose of the present invention, the carbonaceous filler is in the form of a powder and is not in the form of a masterbatch. Preferably, the carbonaceous filler comprises of at least 60 wt. % of carbon black and more preferably at least 80 wt. % of carbon black. Most preferably, the carbonaceous filler consists of carbon black.

In a preferred embodiment, the polymer composition comprises 0.05 to 1 wt. % of the carbonaceous filler relative to the total weight of the polymer composition. More preferably, the polymer composition comprises 0.1 to 0.5 wt. % of the carbonaceous filler relative to the total weight of the polymer composition.

### Other Additives

In the method of manufacturing the polymer composition according to the present invention, in addition to the polymer and the carbonaceous filler, it is possible to add conventional additives such as antioxidants, thermal stabilizers, weathering resistant agents, mold releasing agents, lubricants, coloring agents, plasticizers, antistatic agents, and flame retardants. Colorants, such as pigments or dyes may added to the polymer composition in amounts such as from 10-10000 ppm. The additives may be present in an amount of from 0.1-10 wt. %, based on the weight of the composition.

The additives colorants and/or fillers may be admixed at any stage of the manufacturing operation, but preferably at an early stage in order to profit early on from the stabilizing effects (or other specific effects) of the added substance. Preferably, these are added to the first feed section or any other section closer to the first feed section than to the second feed section.

### Method of Manufacture of the Polymer Composition

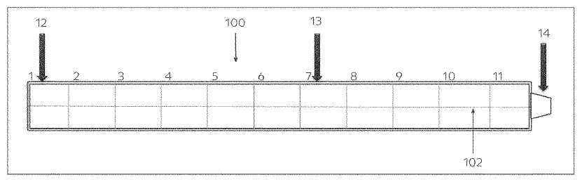

To put the present method in context, a typical process for producing the polymer composition will first be described. A schematic representation of the extruder and some of the method steps according to embodiments of the present invention is schematically shown in FIG. 1, wherein it is noted that the present invention is not limited to the configuration of FIG. 1.

The extruder 100 as shown schematically in FIG. 1 comprises a first feed section 12, second feed section 13 and extrusion die 14. First and second feed sections 12 and 13 comprise conventional feeding means (not shown) for feeding components of polymer compositions to extruder 100, such as hoppers, screw conveyors, injectors and the like. For the purpose of feeding particulate components, such as powders or pellets, hoppers and/or screw conveyors are preferred. In the context of the invention, a feed section is to be understood as the section of extruder 100 where components of the composition are being fed to the same. Multiple components may be added to a feed section as a mixture, such as a particulate mixture, but it is also possible that multiple feeding means are combined in one feed section, of the extruder and where the actual mixing of the components takes place in the extruder. Feeding means are known to the skilled person.

Extruder 100 comprises extrusion zones 1-11, yet the present invention is not limited to such a configuration and extruders with more or less zones may also be applied. In each extrusion zone the temperature and extrusion screw 102 configuration may differ as known to the skilled person.

In general it is preferred that the first feeding zone is located at a first section of the extruder. It is further preferred that the extruder comprises a second feed section located downstream of the first feeding zone of the extruder and upstream of a kneading section.

Feed section 12 is positioned at the first extrusion zone, i.e. the zone where raw materials, i.e. components of the composition, are added. In feed section 12 at least part of the polymer, i.e. the first portion of polymer, and the carbonaceous filler are fed to extruder 100.

Extruder 100 further comprises at least one kneading section (not shown) located downstream of feed section 12. The configuration of kneading sections in an extruder are known to a skilled person per se. Second feed section 13 is located downstream of first feeding 12 zone of extruder 100 and upstream of the kneading section(s). The second portion of polymer and the optional second portion of carbonaceous fillers is fed through second feed section 13.

The method according to the present invention further includes substantially melting and mixing the polymer composition within the extruder. The first portion of polymer moves downstream during the melting and mixing. The second portion of polymer and optional second portion of the carbonaceous filler is introduced into the second feed section, which is located downstream of the first feed section of the extruder.

In the context of the present invention an extruder is to be understood as an apparatus comprising a longitudinal barrel comprising one or two screws extending therein and which are used to transport, melt and mix a polymer composition. The polymer composition moves from an entrance or feed section of the extruder to an exit section thereof, typically formed as a die head. Single screw and counter or co-rotating double screw extruders are very well known to the skilled person. Other types of melt-mixers, such as in particular the Buss co-kneaders as referred to in U.S. Pat. No. 9,056,957 are not to be considered as extruders within the context of the present invention. That is to say, the barrel of the extruder in the context of the invention disclosed herein does not contain retaining rings on its internal surface.

By splitting the feed of polymer into a first polymer portion and a second polymer portion the inventors have found that the dispersion of carbonaceous filler is improved. It is believed that this is due to the drop in temperature of the heated and/or molten first polymer portion once it is combined with the second polymer portion. As a result of the drop in temperature the viscosity of the combined first and second polymer portion increases which results in an increased shear. In turn, the increased shear will break down agglomerates of carbonaceous filler. Such high shear is most pronounced in the kneading section following second feed section 13. Accordingly it is preferred that the second portion of polymer is fed to the extruder at a temperature below the melting point thereof and more preferably in a solid form at a temperature of from 0 to 75° C., preferably 10-50° C.

The method according to the embodiments of the present invention further includes the polymer composition to exit extruder 100 through extrusion die 14.

Specific examples of processing apparatuses for producing the polymer composition of the present invention include, but not limited to a single screw extruder, a twin-screw extruder, a high-speed non-intermeshing counter-rotating twin screw super-kneading mixer (HTM twin screw continuous kneading extruder) and the like.

According to the invention, the weight ratio of the first portion of polymer to the second portion of polymer is from 1:9 to 7:3. It is preferred that the downstream feed of the polymer is higher than the upstream feed. Accordingly, it is preferred that the weight ratio of the first portion of the polymer to the second portion of the polymer is from 1:4 to 2:3. It is important to note that the first portion of polymer and second portion of polymer comprise or consist of the same or different polymer. Further, the second portion of the carbonaceous filler is preferably from 0-20 wt. % based on the total amount of the carbonaceous filler, more preferably from 0-10 wt. % and even more preferably from 0-5 wt. % based on the total amount of the carbonaceous filler.

The present invention further relates to a molded article manufactured from the polymer composition obtained by the above-described method. As the molding method, for example, injection moldings, extrusion moldings, compression moldings, etc., can be used. Further, as the molded articles, injection molded products, sheets, unoriented films, oriented films, round bars, variant extruded products, etc., can also be produced.

The molded article according to the invention has at least 40% less defects per square centimeter, as compared to a molded article prepared with an otherwise identical method wherein the total portion of the polymer is added into the first feed section of the extruder or the polymer composition obtained thereof. This has been determined by the surface aesthetic test method as described below. Thus, the present invention further relates to a molded article obtained by molding the polymer composition obtained or obtainable by the method disclosed herein, wherein preferably the molded article has at least 40% less defects per square centimeter, determined in accordance with the method set out in this description, as compared to a molded article prepared with an otherwise identical method wherein the total portion of the polymer and the carbonaceous filler is added into the first feed section of the extruder or the polymer composition obtained thereof.

### Surface Aesthetic Test Method:

The surface aesthetics was measured using the test method consisting of the following steps:
i. Sample preparation
ii. Evaluation of surface architecture
iii. Defect evaluation & quantification
i. Sample preparation-Molding of a plaque (100×100×3 mm) was executed on an Engel 75T molding machine on a film gated 75×75×3 mm cavity using a high gloss Caveo® coated mirror plate. The molding equipment parameters is provided in Table 1. The extruder was set with temperatures between 150° C. and 300° C.

TABLE 1

| Machine E75T | | Unit of measurement |
|---|---|---|
| Screw | 30 | mm |
| Mold (cavity) | 75 × 75 × 3 | mm |
| Mold (mirror) | High gloss; Caveo ® coated | |

ii. Evaluation of surface architecture—To obtain the surface architecture of a sample, the sample is measured on the Bruker Contour GT interferometer by executing the following steps:
   a. The plaque is placed on a moveable table with the high gloss surface facing the microscope;
   b. The bottom left intersection of the plaque is defined as X=0 and Y=0;
   c. During the measurement the plaque is positioned horizontally d. The plaque is viewed from three fixed locations X-axis, Y-axis (cm): 4, 5 & 5, 5 & 6, 5; the surface of each location in our examples is 4.8 mm².
   e. From each view a picture is saved;
   f. The entire process is repeated on five plaques total (generating 15 images with a cumulative surface of 71.3 mm²).
iii. Defect evaluation & quantification—The images obtained from the Bruker contour GT interferometer as mentioned above were analyzed using FIJI-ImageJ to obtain the number of defects and their sizes. This method helps to detect defects with a certain minimum size. Defects >25 μm in particular are relevant for the appearance, while the defects <25 μm were not significant. Therefore, defects having a diameter larger than 25 μm have only been considered. The number of defects is reported per square centimeter (i.e., Defects >25 μm/cm2).

The polymer composition obtained or obtainable by the method of the present invention can be molded into various molded articles by various conventional methods, such as injection molding, for example, parts for electrical or electronic appliances such as an IC tray, and a chassis and cabinet of various disc players; parts for office automation machines such as various computers and peripheral equipment therefor; mechanical parts; parts for motorcycles such as a cowl; exterior parts for automobiles such as a fender, a door panel, a front panel, a rear panel, a locker panel, a rear bumper panel, a back door garnish, an emblem garnish, a panel for a feeding port of a fuel, an over fender, an outer door handle, a door mirror housing, a bonnet air intake, a bumper, a bumper guard, a roof rail, a roof rail leg, a pillar, a pillar cover, a wheel cover, various aero parts (such as a spoiler), various moles and emblems for an automobile; and interior parts for automobiles such as an instrument panel, a console box and a trim. Among the above-exemplified molded articles, the polymer composition of the present invention is suitable for producing an automobile outer panel.

The present invention will now be further elucidated based on the following non-limiting examples.

### EXAMPLES

Polymer compositions were prepared using a Coperion 26 mm twin screw extruder using the materials indicated in Table 2. All shown samples have been produced with the same composition: Polycarbonate: 99.4 wt. %, PETS: 0.4 wt. %, Irgaphos 168:0.05 wt. % and Carbon black: 0.15 wt. %., the wt. % based on the total weight of the composition. In all the examples, the total amount of components, equals 100 wt. %.

TABLE 2

| | |
|---|---|
| Polycarbonate | Bisphenol A polycarbonate manufactured using an |
| | interfacial process, available from SABIC |
| | (PC 105) having a having a melt volume rate of |
| | 6 cc/10 min, available from SABIC (PC 105). |
| PETS | Pentaerythritol tetra stearate, a mold release |
| | agent purchased from FACI |
| Carbon Black | BLACK PEARLS ® 800 pigment black (BP800) from |
| | CABOT |
| Irgaphos 168 | Antioxidant, tris(2,4-di-tert.-butylphenyl)phosphite, |
| | CAS 31570-04-4, commercially available from BASF |

The composition was pelletized after exiting extrusion die 14.

### Comparative Example 1 (CE1)

CE1 was produced by feeding the total amount of polycarbonate polymer and the carbon black filler in the first feed section of the extruder.

### Examples 1 to 8 (E1 to E8)

While maintaining all other settings identical as in CE1, in samples E1 and E2, 50% of the total amount of polycarbonate polymer was fed in the second feed section located downstream of the first feed section of the extruder and before the kneading section. In sample E3, 75% of the total amount of polycarbonate polymer was fed in the said second feed section. The resulting polymer pellets were molded into plaques in accordance with the method set out above and the resulting plaques were analyzed on surface defects. The formulations and the corresponding defect properties of the polymer composition according to the invention are provided in Table 3.

TABLE 3

| Sample no | CE 1 | E1 | E2 | E3 | E4 | E5 | E6 | E7 | E8 |
|---|---|---|---|---|---|---|---|---|---|
| Polycarbonate | 100 | 50 | 50 | 25 | 50 | 50 | 50 | 50 | 82 |
| feed | | | | | | | | | |
| upstream | | | | | | | | | |
| (Zone “1”) | | | | | | | | | |
| (%) | | | | | | | | | |
| Polycarbonate | 0 | 50 | | | | | | | |
| Feed | | | | | | | | | |
| downstream | | | | | | | | | |
| (Zone “7”) | | | | | | | | | |
| (%) | | | | | | | | | |
| Polycarbonate | | | 50 | 75 | 50 | 50 | 50 | 50 | 18 |
| Feed | | | | | | | | | |
| downstream | | | | | | | | | |
| (Zone “8”) | | | | | | | | | |
| (%) | | | | | | | | | |
| Downstream | NA | Pellet | Pellet | Pellet | Powder | Powder | Powder | Powder | Powder |
| polymer | | | | | | | | | |
| form | | | | | | | | | |
| Carbon | 0.15 | 0.15 | 0.15 | 0.15 | 0.15 | 0.11 | 0.08 | 0 | 0 |
| Black Feed | | | | | | | | | |
| upstream | | | | | | | | | |
| (Zone “1”) | | | | | | | | | |
| % | | | | | | | | | |
| Carbon | 0 | 0 | 0 | 0 | 0 | 0.04 | 0.08 | 0.15 | 0.15 |
| Black Feed | | | | | | | | | |
| downstream | | | | | | | | | |
| (Zone “8”) | | | | | | | | | |
| % | | | | | | | | | |
| Number of | 116 | 23 | 21 | 18 | 30 | 29 | 45 | 70 | 734 |
| defects | | | | | | | | | |
| (Defects | | | | | | | | | |
| diameter >25 | | | | | | | | | |
| μm) | | | | | | | | | |

It was clearly observed that the number of defects having defect diameter >25 μm (measured per Surface aesthetic test method laid in the specifications) of the Examples 1, 2 and 3 (E1, E2 and E3) was significantly lower when compared to CE1.

E4 was produced using polymer powder instead of polymer pellets. Compared to E1 and E2 no difference in the surface quality was observed. E5 and E6 was produced by feeding a portion of the total amount of the carbonaceous filler through the second feed section located downstream of the first feed section of the extruder and before the kneading section. It can be seen that improvement in surface characteristics in terms of reduced surface defects, can still be observed when compared to CE1. However, in case of E7, where the entire amount of the carbonaceous filler is fed through the second feed section, the surface defects is found to increase as compared to E4, E5 and E6. For sample E8, 82% of the total amount of polycarbonate polymer along with the entire amount of the carbonaceous filler was fed in the second feed section. This resulted in very high number of surface defects as compared to CE1.

From the above results, it is apparent from the above results, that polymer compositions comprising carbonaceous fillers show improved surface characteristics in terms of reduced surface defects, when the polymer feed to an extruder is split in accordance with the invention set out herein.

1. Method for the manufacture of a polymer composition comprising polymer and carbonaceous filler comprising;
a. introducing a first portion of polymer and a first portion of carbonaceous filler into a first feed section of an extruder,
b. introducing a second portion of polymer into a second feed section located downstream of the first feed section of the extruder, and
c. extruding the resulting polymer composition;
wherein the polymer composition comprises 0.01 to 3 wt. % of the carbonaceous filler relative to the total weight of the polymer composition.

2. The method of claim 1 wherein the weight ratio of the first portion of polymer to the second portion of polymer is from 1:9 to 7:3.

3. The method of claim 1 wherein the polymer is selected from the group consisting of polycarbonate, polyester, polypropylene, polyethylene, polyamide, polyetherimide, styrene polymers, styrene copolymers and mixtures of two or more of the foregoing polymers.

4. The method of claim 1 wherein the polymer comprises or consists of polycarbonate.

5. The method of claim 1 where the first and/or second portion of polymer is introduced in particulate form.

6. The method of claim 1 wherein the second portion of the carbonaceous filler is from 0-20 wt. % based on the total amount of the carbonaceous filler.

7. The method of claim 1 wherein the carbonaceous filler is selected from the group consisting of graphite, expanded graphite, graphene, carbon fiber, carbon nanotubes, carbon black, or a combination of at least two of the foregoing carbonaceous fillers.

8. The method of claim wherein the carbonaceous filler comprises or consists of carbon black.

9. The method of claim 1 wherein the polymer composition comprises 0.05 to 1 wt. % of the carbonaceous filler relative to the total weight of the polymer composition.

10. The method of claim 1 wherein the first portion of polymer and second portion of polymer comprise or consist of the same or different polymer.

11. The method of claim 1 wherein the first feeding zone is located at a first section of the extruder.

12. A polymer composition obtained by the method according to claim 1.

13. A molded article obtained by molding the polymer composition obtained by the method of claim 1.

14. (canceled)

15. The method of claim 1 wherein the extruder comprises a second feed section located downstream of the first feeding zone of the extruder and upstream of a kneading section.

16. The method of claim 1 wherein in step b. a second portion of carbonaceous filler is also introduced into a second feed section located downstream of the first feed section of the extruder.

17. The method of claim 5 wherein the first and/or second portion of polymer is introduced in the form of pellets or powders.

18. The method of claim 7 wherein the carbonaceous filler is in the form of a powder.
